(19) United States
(12) Patent Application Publication
(10) Pub. No.: US 2025/0009202 A1
(43) Pub. Date: Jan. 9, 2025

(54) The Shoe Cleaning Device

(71) Applicant: Thomas Hunter, Park City, UT (US)

(72) Inventor: Thomas Hunter, Park City, UT (US)

(21) Appl. No.: 18/218,158

(22) Filed: Jul. 5, 2023

(51) Int. Cl. A47L 23/02; B08B 1/00; B08B 3/02; B08B 3/14

(52) U.S. Cl. CPC A47L 23/02; B08B 1/12; B08B 1/165; B08B 3/02; B08B 3/14; B08B 2203/0211; B08B 2203/0264

(57) ABSTRACT

Leave No Trail! is the only product of its kind that is developed specifically to spray off any debris from the bottom of shoes to protect both indoor flooring and the overall aesthetic of the shoe, post necessary cleaning. Leave No Trail! is uniquely designed with an avant-garde water spraying system, is carefully crafted with durable, high-quality materials to ensure long-term sustainability and the unit can be used to clean any and all footwear design, regardless of personal foot size and/or sensitivity of the shoes' fabric.

### BACKGROUND

Cleaning muddy shoes can be a challenging chore and mishandling the shoes while in such a state could cause irreversible damage to the footwear. Moreover, muddy or dirtied footwear will leave a trail of messy footprints, all over floors. These dirty messes can be incredibly tedious and time consuming to clean post traction. There have been no products available as original equipment or as an aftermarket to address this problem.

An apparatus that effectively cleans muddy shoes with ease, is not being met by any known device or system at present. There have been no products available as original equipment or as an aftermarket to address this problem either.

### SUMMARY OF THE INVENTION

The main purpose of the shoe cleaning device is to provide users with a shoe cleaning device that efficiently removes all debris from the bottom of shoes.

A disclosed shoe cleaning device includes a dome lid having a top and a bottom and an opening for receiving a shoe and configured for containing a water spray therein. The disclosure also includes a funnel base attached to the dome lid bottom in a water tight seal and comprising a drain at a narrow opening of the funnel base. The disclosure further includes a water pressure supply lever configured to control a water flow across a water valve to a water supply via a rotational motion. The disclosure yet includes a water sprayer in connection with the water flow and in an inside created by the dome lid and the funnel base and underneath the opening in the dome.

### BRIEF DESCRIPTION OF THE DRAWINGS

FIG. 1 is a front view of the shoe cleaning device in accordance with an embodiment of the present disclosure.

FIG. 2 is a side view of the shoe cleaning device in accordance with an embodiment of the present disclosure.

FIG. 3 is a top elevational view of the shoe cleaning device in accordance with an embodiment of the present disclosure.

Throughout the description, similar reference numbers may be used to identify similar elements depicted in multiple embodiments. Although specific 40 embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

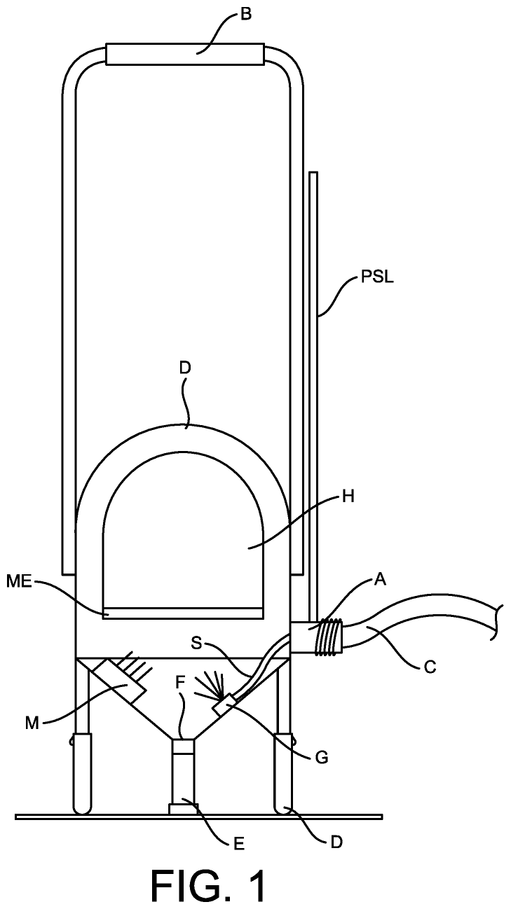

FIG. 1 is a front view of the shoe cleaning device showing: water valve referenced as A, handle referenced as B, water hose referenced as C, dome D, adjustable height legs referenced as L, drain connected to underground pipe with a waste shutoff valve E, water sprayers referenced as G, foot opening referenced as H, and pressure switch lever PSL in accordance with an embodiment of the 60 present disclosure. The water supply line S runs water from the water valve A to the sprayers G. The metal edge ME is a scraper for cleaning excess dirt and debris from the sole of the shoe. A filter F is disposed at the narrow opening of the funnel base to filter large debris from clogging the drain. Brush M is attached to an inner surface of the funnel base where it can brush against a sole of the shoe.

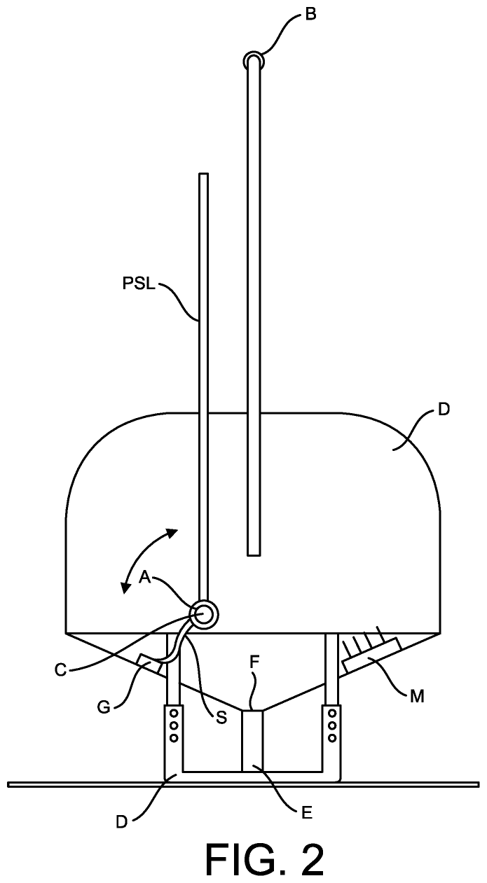

FIG. 2 is a side view of the shoe cleaning device showing: water valve referenced as A, handle referenced as B, water hose referenced as C, Done D, adjustable height legs referenced as L, drain shutoff connected to underground pipe referenced as E, water sprayers referenced as G, in accordance with an embodiment of the present disclosure. Range of motion of the pressure switch lever PSL is indicated by a double headed arrow. The PSL manually controls how much water and head pressure are transferred across the water valve A. The water supply line S runs water from the water valve A to the sprayers G. The filter F prevents large debris from clogging the drain and the waste piping. The Brush M is attached to an inner surface of the funnel base where it can brush against the sole of the shoe.

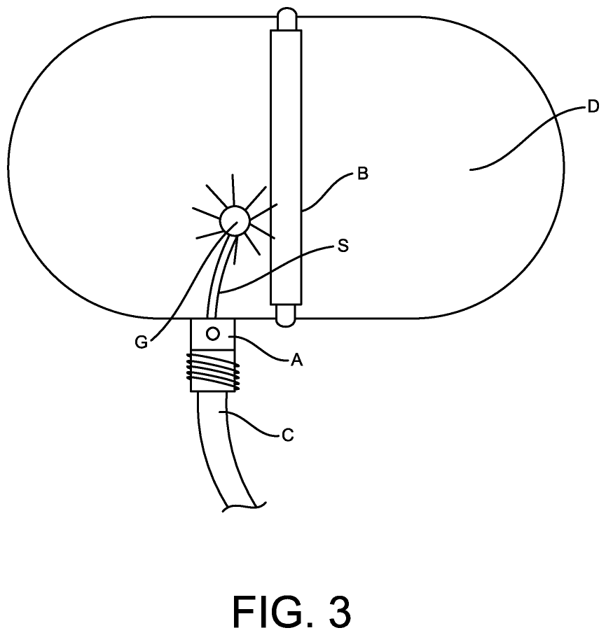

FIG. 3 is a top elevational view of the shoe cleaning device showing: water valve referenced as A, water hose referenced as C, dome D, water sprayers referenced as G, adjustable legs L in accordance with an embodiment of the present disclosure. The PSL is omitted for clarity of depiction. The water supply line S runs water from the water valve A to the sprayers G.

The present disclosed shoe cleaning device, also known as “Leave No Trail!”, offers a modern accessory that ensures users are able to quickly and thoroughly clean their shoes, without manual labor, in effort to prevent both floor damage and shoe mishandling. Leave No Trail! Introduces a novel and hands-free device, possessing a cone shaped bottom connected to a water hose insert and a primary drain hose that works to effectively clean the bottom of any muddy shoe allowing for a more convenient and less messy management process, at all times.

Users simply insert their feet into the apparatus and flip the water spray switch on which prompts the cleaning unit to spray and clean the mud off the bottom of the shoe. To further enhance functionality, Leave Not Trail! Via the drain hose feature eliminates the task of pot-use clean-up as water and mud debris collected can easily flow out of the device for quick disposal.

This innovative, top-quality product can be placed outside or inside of a business, restaurant, hospital and/or residential home, benefiting all individuals who seek to have a more practical and simple means of cleaning dirty and muddy shoes upon entry into an establishment or domestic setting.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A shoe cleaning device comprising:
a dome lid having a top and a bottom and an opening for receiving a shoe and configured for containing a water spray therein;
a funnel base attached to the dome lid bottom in a water tight seal and comprising a drain at a narrow opening of the funnel base;
a water pressure supply lever configured to control a water flow across a water valve to a water supply via a rotational motion; and
a water sprayer in connection with the water flow and in an inside created by the dome lid and the funnel base and underneath the opening in the dome.

2. The shoe cleaning device of claim 1, further comprising a handle configured to enable a pick up and delivery of the shoe cleaning device.

3. The shoe cleaning device of claim 1, further comprising a water hose configured for a transport of the water supply to the water valve.

4. The shoe cleaning device of claim 1, further comprising adjustable height support legs attached to the funnel base.

5. The shoe cleaning device of claim 1, wherein the drain is connected to a waste pipe to convey a waste water collected in the funnel base therefrom.

6. The shoe cleaning device of claim 1, further comprising a water deflecting flap configured to close in an absence of a shoe in the dome opening.

7. The shoe cleaning device of claim 1, wherein the pressure supply lever is configured to turn off and turn on the water flow.

8. The shoe cleaning device of claim 1, further comprising a brush on the inside of the device and to enable a brushing of a bottom of the shoe.

9. The shoe cleaning device of claim 1, wherein the dome lid comprises a transparent material to enable a view of the inside of the dome lid.

10. The shoe cleaning device of claim 1, wherein the opening comprises a scraping lip configured for scraping a debris from a sole of the shoe.

11. The shoe cleaning device of claim 1, further comprising a shutoff valve disposed at the drain and configured to prevent leakage from the device.

12. The shoe cleaning device of claim 1, wherein the water sprayer is adjustable to a sole size of a shoe.

13. The shoe cleaning device of claim 1, wherein the funnel base comprises a metal to transfer a dislodging force to remove a dry debris thereon.

14. The shoe cleaning device of claim 1, further comprising a plurality of water sprayers configured to spray a sole of the shoe from multiple angles.

15. The shoe cleaning device of claim 1, further comprising a filter in the drain configured to prevent debris from entering the drain.
